(19) United States
(12) Patent Application Publication
(10) Pub. No.: US 2022/0224642 A1
(43) Pub. Date: Jul. 14, 2022

(54) OPTICAL DATA ROUTING VIA SWITCHLESS DECISION TREE

(71) Applicant: HEWLETT PACKARD ENTERPRISE DEVELOPMENT LP, Houston, TX (US)

(72) Inventors: MIR ASHKAN SEYEDI, Milpitas, CA (US); TERREL L. MORRIS, Garland, TX (US)

(21) Appl. No.: 17/148,528

(22) Filed: Jan. 13, 2021

(51) Int. Cl. H04L 12/721; H04L 12/741; H04L 12/707; H04L 12/717; H04L 12/751

(52) U.S. Cl. CPC H04L 45/62; H04L 45/74; H04L 45/02; H04L 45/24; H04L 45/42; H04L 45/566

(57) ABSTRACT

A method includes: receiving a packet in an optical domain, the packet including a data payload and a routing header indicative of a routing sequence for the data payload; reading a first bit of the routing header to make a routing decision for the data payload; stripping the first bit of the routing header in the optical domain to generate an updated routing header; and routing the data payload and the updated routing header based on the routing decision.

### DESCRIPTION OF RELATED ART

A packet-level routing protocol is used in typical topologies of data centers and high-performance computing (HPC) applications. Such a protocol encodes a data packet with an address header. The address header contains information of sending and receiving end-points, how long the packet has been in the network, a number of times it has been re-routed, etc. The information allows the protocol to make appropriate decisions regarding if and how and where to route the packet.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example network within which embodiments of the technology disclosed herein can be implemented.

FIG. 2 is a diagram illustrating a node according to one example embodiment.

FIG. 3 is a diagram illustrating an encoded packet in a time-power-wavelength space, according to one example embodiments.

FIG. 4 is a flow chart illustrating a method for routing packets in a network according to one example embodiment.

FIG. 5 is a flow chart illustrating a packet encoding and routing logic in a communication network according to one example embodiment.

FIG. 6 is a flow chart illustrating a packet routing logic in a communication network according to one example embodiment.

FIG. 7 is a block diagram illustrating a node, according to one example embodiment.

The figures are not exhaustive and do not limit the present disclosure to the precise form disclosed.

### DETAILED DESCRIPTION

The current packet routing protocols provide flexibility and robustness of routing packets over an optical communication network. For example, a packet is given an address header that includes routing information. When a node in the network receives the packet in an optical domain, the node first converts the optical signals of the packet including the address header and the payload of the packet from the optical domain (optical signals) to the electrical domain (electrical signals), and stores the electrical signals at a buffer. The node then reads the address header in the electrical domain to determine where to send the packet to. Once a routing decision is made, the address header and the payload of the packet are read from the buffer and converted to optical signals to be transmitted to the optical communication network.

Such protocol implementations come at the expense of intricate hardware-aware design for the protocol, electrical buffering for storing the data (header and payload) and latencies in the routing and converting. Further, the header reduces the effective data bandwidth of the communication network as the bits that comprise the header are not meaningful data for the workload that sends the data. While these conveniences of such protocols might be desired for certain applications, certain HPC workloads may suffer significant latencies.

As optical interconnects are increasingly implemented within communication networks, including serving as the fabric for HPC implementations, latency is further increased due to the need for optical to electrical conversions. Optical communications provide higher bandwidth potential over traditional electrical cabling and can transmit signals effectively over longer distances. However, the data must be converted into the electrical domain in order for the processors of the nodes to use the received data. Not only must the optical data be converted into the electrical domain for the processor to interpret, if the data is meant for a different endpoint or node, the data must be converted back into the optical domain for transmission. This increases the latency in message response.

Embodiments of the technology disclosed herein provides systems and methods for optical routing of data packets. The technology reduces the latency of data transmission between nodes within a networking fabric by keeping the routing of data packets entirely in the optical domain before any optical-to-electrical conversions. In various embodiments, each node within the network includes a photonics circuit configured to transmit and receive optical signals. The technology allows routing decision-making in the optical domain. In some embodiments, a bit is used to route a packet one way or another at a decision-making circuit. That bit is then stripped off from the overall packet. The technique uses very minimal overhead and effectively increases the payload to near 100%. In some implementations, the need for buffering and complicated protocols are eliminated by allowing the hardware of a node to make routing decisions in the optical domain. Buffering can be eliminated as paths are open for traffic and there is no contention in the system. Elimination of the software-level decisions enables that the data may be transmitted through the network substantially at the speed of light.

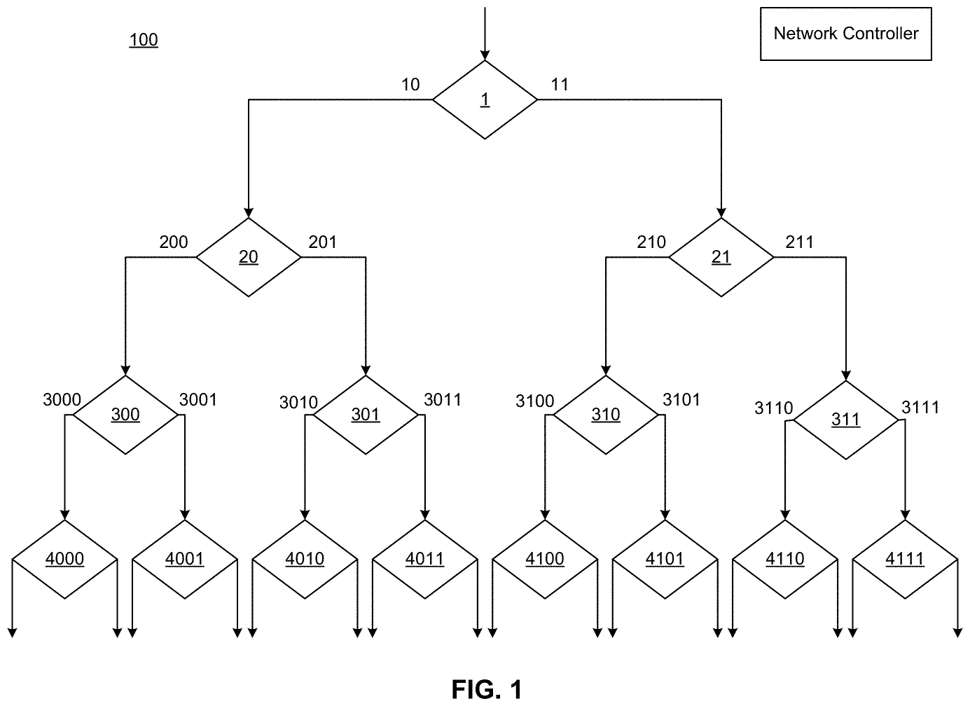

FIG. 1 illustrates an example network 100 within which embodiments of the technology disclosed herein can be implemented. The example network 100 is provided for illustrative purposes only and should not limit the scope of the technology to only the depicted embodiment. For ease of discussion, the network 100 is depicted as a high-performance computing (HPC) system, but the technology is not limited to only HPC systems or environments. The technology of the present disclosure is applicable to any network or system in which data is transmitted over an optical interconnect fabric. As shown in FIG. 1, the network 100 includes a plurality of nodes 1, 20, 21, 300, 301, 310, 311, 4000, 4001, 4010, 4011, 4100, 4101, 4110, and 4111. As can be appreciated, the network 100 may include more or less nodes. Each of the nodes may include two output ports labeled 1 (e.g., to the right of each node) or 0 (e.g., to the left of each node) (herein after “output port 1” or “output port 0”). The output ports as shown in FIG. 1 is named where the first digit(s) is the node number and the last digit is the output port number. For example, the output port 3010 to the left of the node 301 is named 3010, where the first three digits is the node number 301 and the last digit represents the output port number 0. Based on this naming rule, the node 1 has output ports 10 and 11; the node 20 has output ports 200 and 201; the node 21 has output ports 210 and 211; the node 300 has output ports 3000 and 3001; the node 301 has output ports 3010 and 3011; the node 310 has output ports 3100 and 3101; and the node 311 has output ports 3110 and 3111. The output ports for the fourth level nodes 4000, 4001, 4010, 4011, 4100, 4101, 4110, and 4111 are omitted.

The network 100 further includes a network controller 102 coupled to each of the nodes of the network 100. The network controller 102 is configured to provision and control the nodes of the network 100. In some embodiments, the network controller 102 may provision each of the nodes such that each of the nodes, upon receiving a packet in the optical domain, is to read the first bit of a routing header of the packet to make a routing decision for the packet, strip the first bit of the routing header, and route the remainder of the packet to the network based on the routing decision. In some embodiments, a routing header may be encoded as a binary string.

As a non-limiting example, a routing header of a packet may be a binary string “100.” After the node 1 receives the packet and reads the first bit “1” of the routing header, the node 1 can make a routing decision such that the packet is to be transmitted through its output port 11 (i.e., to the right of the node 1). The first bit “1” is then stripped from the binary string such that the packet now has an updated routing header with a binary string “00.” The packet is then transmitted from the output port 11 of the node 1 to the node 21. The node 21 receives the packet and reads the first bit “0” of the updated routing header “00” to make a routing decision such that the packet is to be transmitted through its output port 210 (i.e., to the left of the node 21). The first bit “0” of the updated routing header is then stripped from the binary string such that the packet now has a routing header with a binary string “0.”

The packet is then transmitted from the output port 210 of the node 11 to the node 310. The node 310 receives the packet and reads the first bit “0” of the routing header to make a routing decision such that the packet is to be transmitted through its output port 3100 (i.e., to the left of the node 310). The first bit “0” of the routing header is then stripped from the binary string such that the routing header contains no routing data/binary string or the routing header is now eliminated. At this point, the packet contains only the payload and no routing header. The packet is then transmitted from the output port 3100 of the node 310 to the node 4100. Because the packet contains no routing header, indicating that the receiving node is the destination of the packet, the node 4100 does not make any routing decision and can proceed to convert the optical payload to electrical signals.

Based on these techniques, the nodes (“intermediate nodes”) that are not the destination of packet in the optical domain can make a routing decision without converting the optical signals (e.g., the payload) they receive into electrical signals. This reduces the latencies associated with the conventional routing protocols that require optical-to-electrical conversion in order for processors to read the routing header to make routing decisions. Moreover, because of no optical-to-electrical conversion, the intermediate nodes do not need to buffer the packet in the electrical domain and then convert the electrical signals back to optical signals in order to transmit the packet to its destination in the network after the routing decision is made. Further, according to the disclosed techniques, the size of the routing header of the packet is gradually reduced as the packet is transmitted through the intermediate nodes, which in term reduces the overall bandwidth required to transmit the packet in the network.

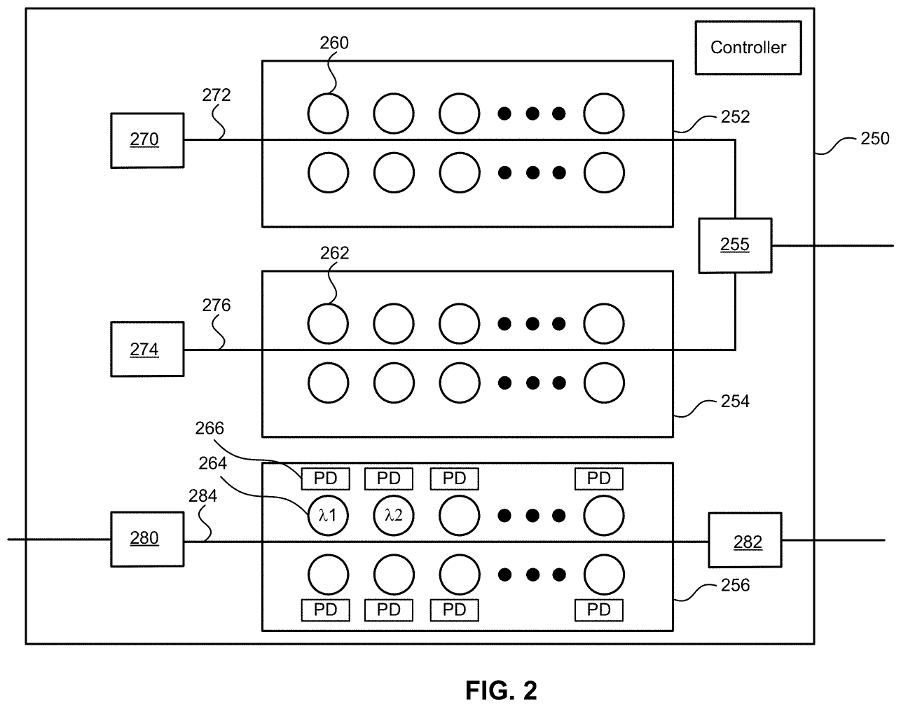

To implement these techniques, each of the nodes in the network 100 may be provided with a routing decision-making circuit to make a routing decision. FIG. 2 is a diagram illustrating a node 250 according to one example embodiment. The node 250 can be any one of the nodes shown in FIG. 1. The node 250 includes a routing header encoder 252, a data payload encoder 254, an optical multiplexer 255, a routing decision-making circuit 256, and a controller 258. The routing header encoder 252 includes one or more ring resonators 260 (one is labeled in FIG. 2) each configured to modulate a different wavelength. The routing header encoder 252 is configured to receive routing information for a data payload from the controller 258 and encode the routing information into a routing header for the data payload. In some embodiments, the routing header encoder 252 may use one or more of the ring resonators 260 to encode the routing information into a binary bit string having one or more bits. The routing header encoder 252 is coupled to a light source 270 and a waveguide 272. In some embodiments, the light source 270 may include any light-emitting devices, such as lasers. In some embodiments, the light source 270 may be a comb laser that can emit multiple different wavelengths of light into the waveguide 272, or one or more single-wavelength lasers.

The data payload encoder 254 includes one or more ring resonators 262 (one is labeled in FIG. 2) each configured to modulate a different wavelength. In some embodiments, each of the ring resonators 260 and 262 is configured to modulate a different wavelength. The data payload encoder 254 may use one or more of the ring resonators 262 to encode the data payload into optical signals. The encoded routing header and data payload are multiplexed by the optical multiplexer 255 and transmitted to a next node in the network. The data payload encoder 254 is coupled to a light source 274 and a waveguide 276. In some embodiments, the light source 274 may include any light-emitting devices, such as lasers. In some embodiments, the light source 274 may be a comb laser that can emit multiple different wavelengths of light into the waveguide 276, or one or more single-wavelength lasers.

The routing decision-making circuit 256 includes one or more ring resonators 264 (one is labeled in FIG. 2) each configured to modulate a different wavelength. The one or more ring resonators 264 may modulate a set of wavelengths that are same as or different from those modulated by the ring resonators 260 and 262. The routing decision-making circuit 256 is coupled to an optical transceiver 280 to the left and another optical transceiver 282 to the right. For example, when a packet is received at the optical transceiver 280, the optical signals of the packet are transmitted on a waveguide 284 to the routing decision-making circuit 256. The ring resonators 264 are coupled to the waveguide 284 and configured to extract the optical signals of the packet. Each of the ring resonators 264 is coupled to a photodetector (PD) 266 (one is labeled in FIG. 2). Each of the photodetectors 266 is configured to convert light signals extracted by a corresponding ring resonator 264 into electrical signals for the controller 258.

For example, a packet may include a routing header encoded with a wavelength λ1 and a data payload encoded with another wavelength λ2. When the packet is received at the routing decision-making circuit 256, the ring resonator 264 labeled with “λ1” is configured to extract/read a first bit of the routing header. The optical signal extracted by the ring resonator 264 is converted to an electrical signal, which is sent to the controller 258 to make a routing decision. In some implementations, the function of making a routing decision of the controller 258 may be integrated with/disposed at the decision-making circuit 256. Based on the routing decision, the controller 258 may direct the optical transceiver 282 to transmit the packet to a next node in the network. In some embodiments, if the routing header contains no data or the decision-making circuit 256 does not detect any routing header, the controller 258 can make a decision that it is the destination of packet and direct the ring resonator 264 labeled with “λ2” to extract the optical signals of the data payload that is encoded with wavelength λ2.

Although the controller 258 is illustrated as independent from other components of the node 250, in some embodiments the control functions of the controller 258 may be broken down into individual control blocks and integrated with the routing header encoder 252, the data payload encoder 254, and the routing decision-making circuit 256, respectively.

As each node of the network 100 has the configurations illustrated in FIG. 2, each node of the network 100 is able to generate an encoded packet, receive an encoded packet, and make a decision to route an encoded packet.

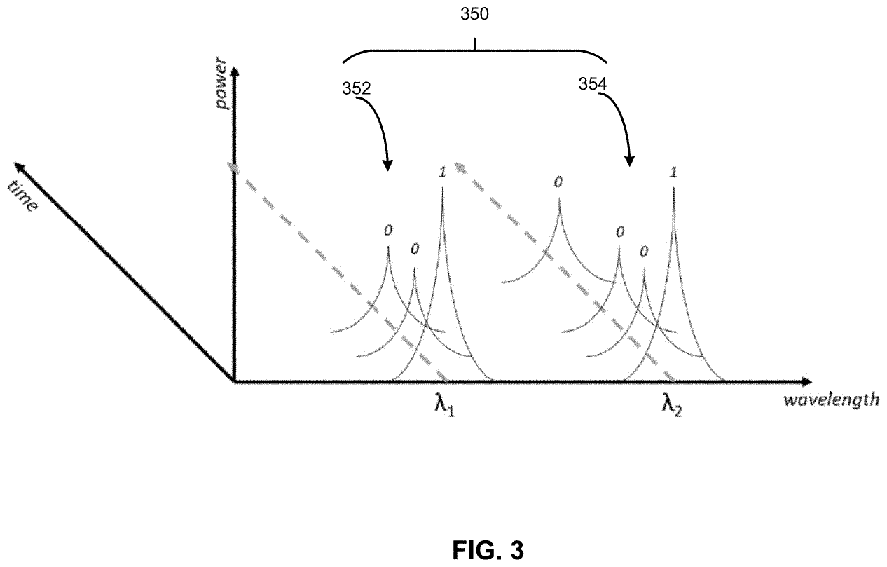

FIG. 3 is a diagram illustrating an encoded packet 350 in a time-power-wavelength space, according to one example embodiment. The packet 350 includes a routing header 352 encoded with a wavelength λ1 and a data payload 354 encoded with a wavelength λ2 different from the wavelength λ1. For example, the routing header 352 may be encoded by a ring resonator 260 of the routing header encoder 252 (FIG. 2), while the data payload. 354 may be encoded by a ring resonator 262 of the data payload encoder 254. The routing header 352 includes a binary string consisting of three digits “100.” It can be appreciated that this is provided as an example. The routing header 352 may include a binary string of more or less than three digits. In some embodiments, the data payload may include signals encoded with multiple different wavelengths.

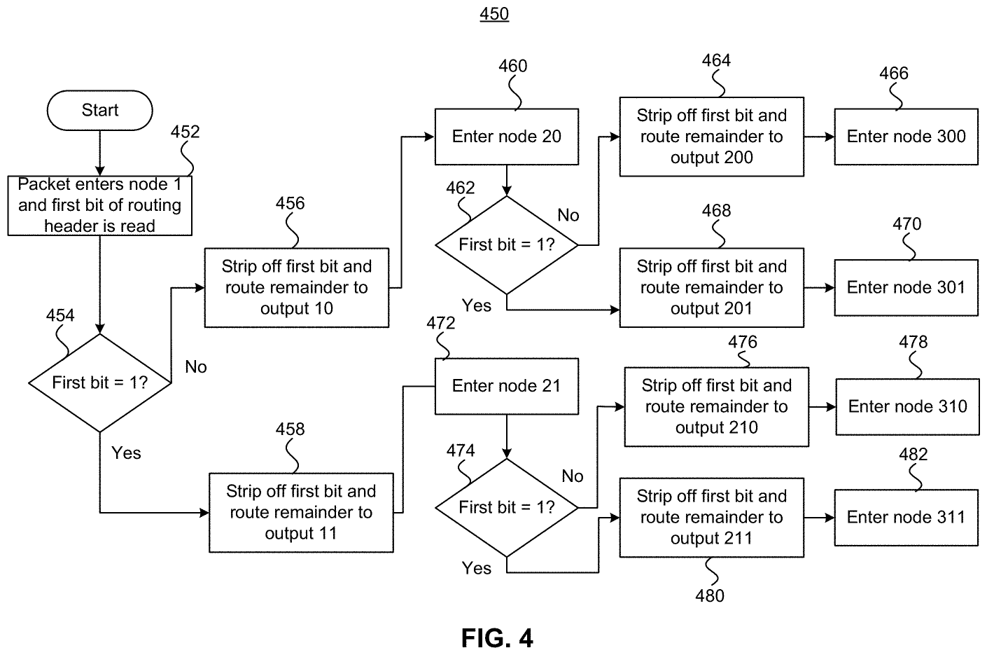

FIG. 4 is a flow chart illustrating a method 450 for routing packets in a network according to one example embodiment. The method 450 can be implemented in the network 100 of FIG. 1. With reference to both FIGS. 1 and 4, at 452 a packet is received at the node 1. The packet may be received from an upstream node or generated at the node 1. The packet includes a routing header and a data payload. The routing header is read to determine how to route the packet. In the illustrated embodiment, the routing header includes a binary string having one or more bits. At 454, the node 1 determines whether the first bit of the routing header is one (1). If the first bit of the routing header is not one (e.g., zero) (No at 454), at 456 the first bit of the routing header is stripped to generate an updated routing header. The updated routing header and the data payload (collectively the “remainder”) are routed through the output port 10 of the node 1. If the first bit of the routing header is one (Yes at 454), at 458 the first bit of the routing header is stripped to generate an updated routing header. The updated routing header and the data payload (collectively the “remainder”) are routed through the output port 11 of the node 1.

At 460, the node 20 receives the remainder and reads the first bit of the updated routing header. At 462, the node 20 determines whether the first bit of the updated routing header is one (1). If the first bit of the updated routing header is not one (e.g., zero) (No at 462), at 464 the first bit of the updated routing header is stripped to generate a second-updated routing header. The second-updated routing header and the data payload (collectively the “remainder”) are routed through the output port 200 of the node 20. At 466, the remainder is received at the node 300.

If the first bit of the updated routing header is one (Yes at 462), at 468 the first bit of the updated routing header is stripped to generate a second-updated routing header. The second-updated routing header and the data payload (collectively the “remainder”) are routed through the output port 201 of the node 20. At 470, the remainder is received at the node 301.

Following 458, at 472, the node 21 receives the remainder and reads the first bit of the updated routing header. At 474, the node 20 determines whether the first bit of the updated routing header is one (1). If the first bit of the updated routing header is not one (e.g., zero) (No at 474), at 476 the first bit of the updated routing header is stripped to generate a second-updated routing header. The second-updated routing header and the data payload (collectively the “remainder”) are routed through the output port 210 of the node 21. At 478, the remainder is received at the node 310.

If the first bit of the updated routing header is one (Yes at 474), at 480 the first bit of the updated routing header is stripped to generate a second-updated routing header. The second-updated routing header and the data payload (collectively the “remainder”) are routed through the output port 211 of the node 21. At 482, the remainder is received at the node 311. As can be appreciated, the above algorithm can be applied to the nodes 300, 301, 310, and 311, or another nodes in the network 100 to route the data payload until it arrives at the destination node.

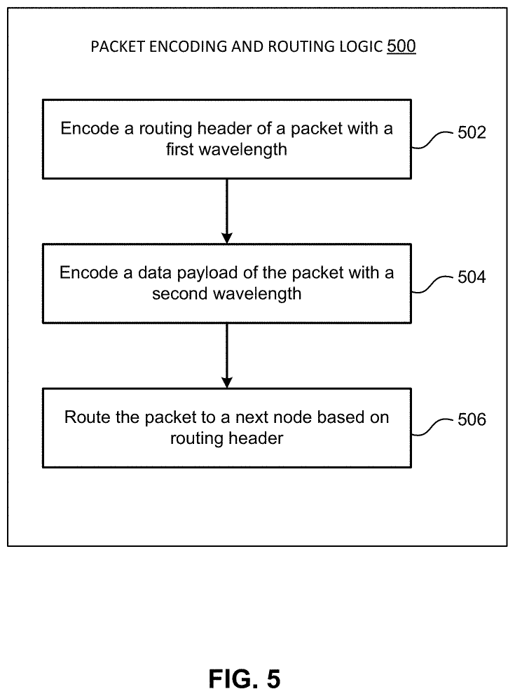

FIG. 5 is a flow chart illustrating a packet encoding and routing logic 500 in a communication network according to one example embodiment. For example, the method 500 may be performed by any node of the network 100 of FIG. 1. At 502, the node encodes a routing header of a packet with a first wavelength in the optical domain. For example, the node may include a routing header encoder (e.g., the routing header encoder 252 of FIG. 2) configured to encode the routing header into a binary string. In some embodiments, the routing header encoder may include one or more ring resonators to performed the encoding. At 504, the node encodes a data payload of the packet with a second wavelength different from the first wavelength in the optical domain. For example, the node may include a data payload encoder (e.g., the data payload encoder 254 of FIG. 2) configured to encode the data payload. In some embodiments, the data payload encoder may include one or more ring resonators to encode the data payload. At 506, the node routes the encoded packet having the routing header and the data payload to a next node based on the routing header.

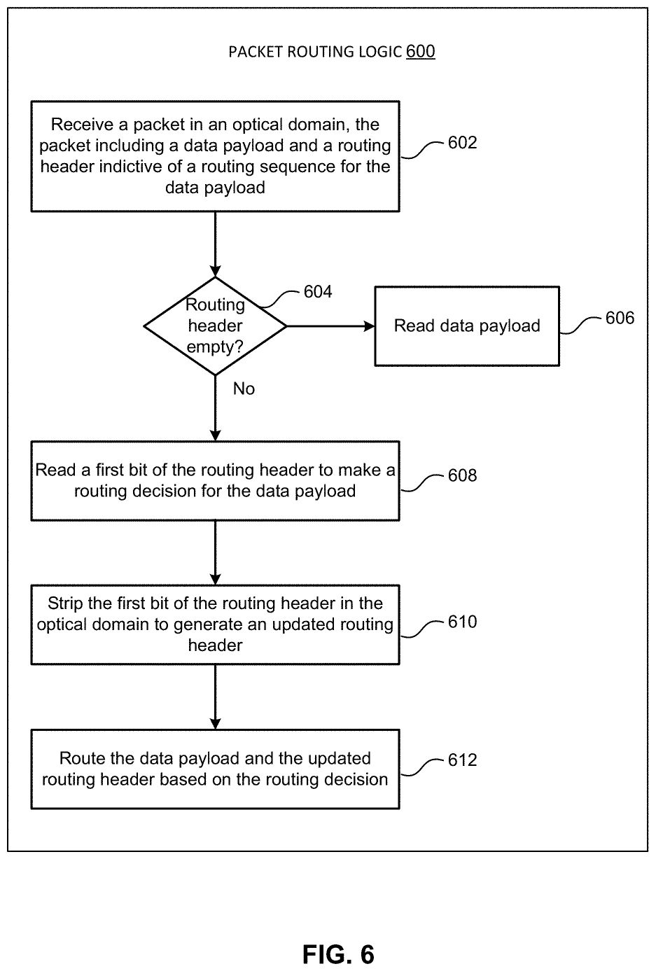

FIG. 6 is a flow chart illustrating a packet routing logic 600 in a communication network according to one example embodiment. For example, the method 600 may be performed by any node of the network 100 of FIG. 1. At 602, a node in the communication network receives a packet in the optical domain. The packet includes a data payload and a routing header indicative of a routing sequence for the data payload. At 604, the node determines whether the routing header is empty (e.g., contains no routing data). For example, the node may include a routing decision-making circuit (e.g., the routing decision-making circuit 256 of FIG. 2) that can read the routing header. In response to determining that the routing header is empty (Yes at 604), at 606 the node reads the data payload. When the routing header contain no routing data, the node can determine that the data payload is addressed to itself such that the node can employ the routing decision-making circuit to read the data payload.

In response to determining that the routing header is not empty (No at 604), at 608 the node reads a first bit of the routing header to make a routing decision for the data payload. At 610, the node strips the first bit of the routing header in the optical domain to generate an updated routing header. At 612, the node routes the data payload and the updated routing header based on the routing decision to a next node in the network, without converting the optical data payload into electrical signals and without buffering the data payload at the node.

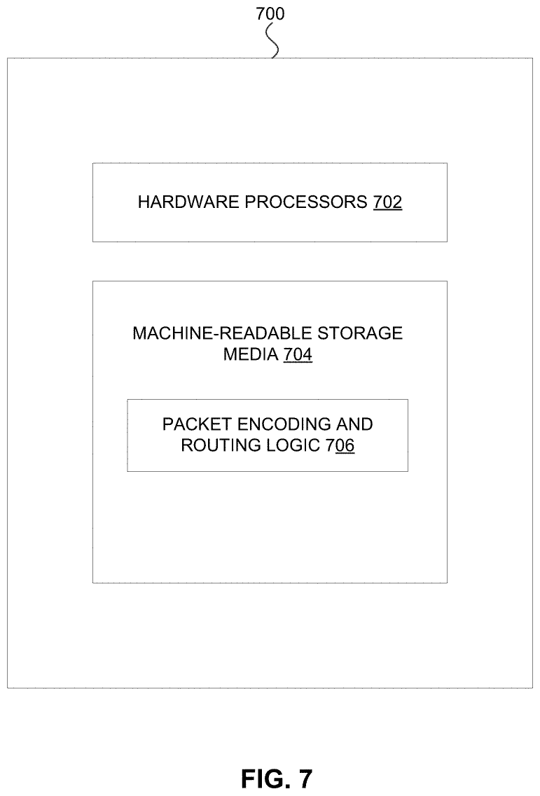

FIG. 7 is a block diagram illustrating a node 700, according to one example embodiment. The node 700 may be adopted as any node of FIGS. 1 and 2. The node 700 includes one or more hardware processors 702 and one or more non-transitory machine-readable storage media 704. The machine-readable storage media 704 store packet encoding and routing logic 706, such as those disclosed in FIGS. 5 and 6.

The node 700 may implement the techniques described herein using customized hard-wired logic, one or more ASICs or FPGAs, firmware and/or program logic which in combination with the computer system causes or programs the node 700 to be a special-purpose machine. According to one embodiment, the techniques herein are performed by the node 700 in response to processor(s) 702 executing one or more sequences of one or more instructions of the packet encoding and routing logic 706 contained in the storage media 704. Execution of the sequences of instructions contained in the storage media 704 causes processor(s) 702 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks. Volatile media includes dynamic memory. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

In summary, the disclosed techniques enables bit-level decision making for optical packet routing, purely in the optical domain. As the encoded data packet propagates through each decision point (e.g., intermediate node), the bit used for making decision is removed. Furthermore, the techniques eliminate the need for optical to electrical transition and electrical buffers. Further, by enabling decision-making in the optical domain, the techniques can be applied to optical computing to be combined with optical data transmission.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality.

In general, the word “component,” “engine,” “system,” “database,” “data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

In common usage, the term “or” should always be construed in the inclusive sense unless the exclusive sense is specifically indicated or logically necessary. The exclusive sense of “or” is specifically indicated when, for example, the term “or” is paired with the term “either,” as in “either A or B.” As another example, the exclusive sense may also be specifically indicated by appending “exclusive” or “but not both” after the list of items, as in “A or B, exclusively” and “A and B, but not both.” Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

1. A method, comprising:
receiving a packet in an optical domain, the packet including a data payload and a routing header indicative of a routing sequence for the data payload, wherein the routing header is encoded with a first wavelength and the data payload is encoded with a second wavelength;
reading a first bit of the routing header encoded with a first wavelength to make a routing decision for the data payload in the optical domain, wherein the data payload remains encoded with the second wavelength;
stripping the first bit of the routing header in the optical domain to generate an updated routing header; and
routing the data payload and the updated routing header in the optical domain and based on the routing decision.

2. The method of claim 1, wherein
the second wavelength of the data payload is different from the first wavelength of the routing header.

3. The method of claim 2, wherein the routing header comprises a binary bit string.

4. The method of claim 1, wherein the first bit of the routing header is read by a ring resonator.

5. The method of claim 1, wherein the routing is performed without converting the data payload and the updated routing header from the optical domain to an electrical domain.

6. The method of claim 1, wherein the updated routing header contains no data.

7. A node of a communication network, the node comprising:
a receiver configured to receive a packet in an optical domain, the packet including a data payload and a routing header indicative of a routing sequence for the data payload, wherein the routing header is encoded with a first wavelength and the data payload is encoded with a second wavelength;
a decision-making circuit configured to read a first bit of the routing header encoded with a first wavelength to make a routing decision for the data payload in the optical domain, wherein the data payload remains encoded with the second wavelength and strip the first bit of the routing header in the optical domain to generate an updated routing header; and
a transmitter configured to route the data payload and the updated routing header to another node of the communication network in the optical domain and based on the routing decision.

8. The node of claim 7, wherein
the second wavelength of the data payload is different from the first wavelength of the routing header.

9. The method of claim 8, wherein the routing header comprises a binary bit string.

10. The node of claim 7, wherein the decision-making circuit comprises one or more ring resonators configured to read the first bit of the routing header.

11. The node of claim 7, wherein the transmitter is configured to route the data payload and the updated routing header without converting the data payload and the updated routing header from the optical domain to an electrical domain.

12. The node of claim 7, wherein the updated routing header contains no data.

13. A communication network comprising: a first node, a second node, and one or more intermediate nodes coupled between the first node and the second node, wherein:
the first node is configured to transmit in an optical domain a packet to a first intermediate node of the one or more intermediate nodes, wherein the packet includes a routing header and a data payload, wherein the routing header indicates a routing sequence for the data payload;
the first intermediate node is configured to:
receive the packet in the optical domain, wherein the routing header is encoded with a first wavelength and the data payload is encoded with a second wavelength;
read a first bit of the routing header encoded with the first wavelength to make a routing decision for the data payload in the optical domain, wherein the data payload remains encoded with the second wavelength;
strip the first bit of the routing header in the optical domain to generate a first-updated routing header; and
route the data payload and the first-updated routing header in the optical domain and based on the routing decision to a node coupled to the first intermediate node; and
the second node is configured to receive the data payload with no routing header.

14. The communication network of claim 13, wherein the first node comprises:
a first encoder configured to encode the routing header with the first wavelength; and
a second encoder configured to encode the data payload with the second wavelength different from the first wavelength.

15. The communication network of claim 14, wherein the routing header comprises a binary bit string.

16. The communication network of claim 15, wherein each of the one or more intermediate nodes is configured to strip one bit of the binary bit string.

17. The communication network of claim 16, wherein the binary bit string has N bits and the one or more intermediate nodes include N intermediate nodes, where N is an integer and N≥1.

18. The communication network of claim 13, wherein the node coupled to the first intermediate node is a second intermediate node of the one or more intermediate nodes and the routing decision is a first routing decision, wherein the second intermediate node is configured to:
receive the data payload and the first-updated routing header;
read a first bit of the first-updated routing header to make a second routing decision for the data payload in the optical domain, wherein the data payload remains encoded with the second wavelength;
strip the first bit of the first-updated routing header in the optical domain to generate a second-updated routing header; and
route the data payload and the second-updated routing header in the optical domain and based on the second routing decision to a node coupled to the second intermediate node in the communication network.

19. The communication network of claim 18, wherein two nodes are coupled to the second intermediate node, wherein the second routing decision selects one of the two nodes to receive the data payload and the second-updated routing header.

20. The communication network of claim 19, wherein the second-updated routing header contains no data.
